(19) United States
(12) Patent Application Publication
(10) Pub. No.: US 2008/0122868 A1
(43) Pub. Date: May 29, 2008

(54) IMAGE PROCESSING APPARATUS AND IMAGE PROCESSING METHOD

(75) Inventors: Norio Mizutani, Mie-ken (JP); Kousuke Fukaya, Chiryu-shi (JP); Kunihiko Sakurai, Gifu-shi (JP); Sadaaki Miyazaki, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/772,920

(22) Filed: Jul. 3, 2007

(30) Foreign Application Priority Data
Jul. 5, 2006 (JP) 2006185752

(51) Int. Cl. G06T 11/60

(52) U.S. Cl. 345/629

(57) ABSTRACT

An image processing apparatus includes an overwriter, an area storage, and a controller. The overwriter overwrites a plurality of images over another image by performing a transparent process in a writing order from one of the plurality of images disposed uppermost. The area storage stores areas in each of which each of the plurality of images is written by the overwriter. The controller controls the overwriter so as to write the plurality of images such that, when each of the plurality of images is written in the writing order, the areas of the plurality of images do not overlap with the areas already stored by the area storage.

### CROSS-REFERENCE TO RELATED APPLICATIONS

This application claims the benefit of Japanese Patent Application No. 2006-185752 filed Jul. 5, 2006 in the Japan Patent Office, the disclosure of which is incorporated herein by reference.

### BACKGROUND

This invention relates to an image processing apparatus and an image processing method wherein a plurality of object images are overlapped. Particularly, the present invention relates to an image processing apparatus and an image processing method wherein a group of object images are overlapped with another object image or a background by a transparent process.

When an object image, such as a graphic symbol, a graphical form, an image, and so on, is overlapped with another object image, the overlapping is generally performed by writing one object image over another object image. That is, the color of a portion of an underlying object image, overlapping with an overlying object image, is changed into the color of the overlying object image.

In some cases, a transparent process is alternatively performed wherein a desired degree of opacity is assigned to an overlying object image so that the color of an underlying object image immediately beneath the overlying object image becomes transparent. This transparent process is performed as follows.

For example, an overlying object image 902, shown in FIG. 11A, is placed over an underlying object image 901. When both object images 901, 902 are put together, as shown in FIG. 11B, the color of an overlapping portion 903 becomes a blended color obtained by calculating the following formula.

BL=(1−α)*CUO+a*COO
BL: blended color
CUO: color of underlying object image
COO: color of overlying object image

In the above formula, a represents a degree of opacity having a value between 0.0 and 1.0 (when the value is 1.0, the color of an underlying object image does not become transparent, but is overwritten by the color of an overlying object image). Colors are assigned with numeric color values which specify the colors among, for example, 256 shades.

As shown in FIG. 11A, when a single object image is overwritten on an another object image by the transparent process, the writing of the single object image can be performed by calculating blended colors by the above-described formula. However, in case of writing a group of object images, constituted by sequentially writing a plurality of object images over one another, over another object image by the transparent process, the above-described method cannot be used without modifying the method.

FIGS. 12A and 12B show an example wherein an object image 910 is written over another object image 920 by the transparent process. The object image 910 is constituted by sequentially overwriting object images 911-919 shown in FIG. 12A (FIG. 13 shows a positional relation of the respective object images 911-919).

In FIG. 13, the object image 911 partially overlaps with the respective object images 912, 913, 914, and 915. The object images 912 and 913 partially overlap with each other. The object images 913 and 914 partially overlap with each other. The object images 914 and 915 partially overlap with each other. The object images 915 and 912 partially overlap with each other. An object image 916, forming a corner portion of the object image 910, partially overlaps with the object images 911, 912, and 913. Similarly, an object image 917 partially overlaps with the object images 911, 913, and 914. An object image 918 partially overlaps with the object images 911, 912, and 915. An object image 919 partially overlaps with the object images 911, 914, and 915.

In this case, an image as shown in FIG. 14 is supposed to be obtained. FIG. 14 shows a state wherein the object image 920 is transparent and seen through the object image 910. The object image 910 is constituted with the object images 911, 912, 913, 914, 915, 916, 917, 918, and 919 sequentially written over one another in this order. In the overlapping portion of the object image 910, the color of the object image disposed uppermost is apparent. Therefore, in FIG. 14, the object image 910 is formed by a square portion 910a and a frame portion 910b surrounding the square portion 910a. An inner frame 910c and an outer frame 910d shown in FIG. 14 respectively correspond with an inner frame 910c and an outer frame 910d shown in FIG. 13.

However, when the object image 911 is written over the object image 920 by the transparent process, and the object image 912 is subsequently written thereover by the transparent process, as shown in FIG. 15, the color of the object image 911, which is not supposed to be shown, appears in the overlapping portion 911a of the object images 911 and 912.

An alternative transparent process has been conventionally proposed for processing images constituted with a plurality of graphical forms overlapping with one another. In this transparent process, for each of overlapping portions of the respective graphical forms is tagged, and the transparent process is performed with respect to each of the tagged portions.

In the example of FIG. 15, the following portions are respectively tagged, as shown in FIG. 16: (A) a portion of the object image 911 not overlapping with other object images; (B) a portion of the object image 912 not overlapping with other object image; (C) a portion of the object image 920 not overlapping with other object images; (D) an overlapping portion of the object images 911 and 912; (E) an overlapping portion of the object images 911 and 920; (F) an overlapping portion of the object images 912 and 920; and (G) an overlapping portion of the object images 911, 912, 920. The transparent process is performed depending on the state of each of the overlapping portions. In this case, colors can be assigned to the respective portions (A)-(G) as follows. The portions (A), (B) and (C) are respectively assigned with the colors of object images 911, 912, and 920. The portion (D) is assigned with the color of the object image 912. The portion (E) is assigned with a blended color wherein the color of the object image 920 is blended with the color of the object image 911. The portions (F) and (G) are assigned with a blended color wherein the color of the object image 920 is blended with the color of the object image 912.

### SUMMARY

However, in a case wherein each of overlapping portions of a plurality of graphical forms is tagged as described above, as the number of object images increases, the number of tags becomes extremely large. Therefore, an enormous memory capacity is required for performing the above-described process. Alternatively, other methods are conceivable: a transparent process method wherein data is saved in a separate memory as data in full-color prior to a transparent process, and then a transparent process is performed; a method wherein a group of object images (for example, the above-described object images 911-919) are merged as a uniform image; and so on. However, in any of these methods, a very large memory capacity is required.

One aspect of the present invention provides an image processing apparatus and an image processing method wherein a transparent process can be suitably performed with a small memory capacity even when a group of object images, constituted with a plurality of object image sequentially written over one another, is overlapped on another object image or a background.

In one aspect of the present invention, an image processing apparatus includes an overwriter, an area storage, and a controller. The overwriter overwrites a plurality of images over another image by performing a transparent process in a writing order from one of the plurality of images disposed uppermost. The area storage stores areas in each of which each of the plurality of images is written by the overwriter. The controller controls the overwriter so as to write the plurality of images such that, when each of the plurality of images is written in the writing order, the areas of the plurality of images do not overlap with the areas already stored by the area storage.

In the image processing apparatus configured as above, an underlying image included in a group of images is inhibited from being overwritten in an area in which overlying images included in the group of images are written. Therefore, the transparent process can be performed by a simple process with respect to the group of images.

Moreover, in the image processing apparatus according to the present invention, the transparent process can be appropriately performed by a simple process wherein overwriting of images are performed such that areas, stored by the area storage, do not overlap, Furthermore, the data, stored by the area storage, can be two-dimensional binary data indicating whether or not overwriting is performed. Therefore, only a small storage capacity is required.

### BRIEF DESCRIPTION OF THE DRAWINGS

The invention will now be described below, by way of example, with reference to the accompanying drawings, in which:

FIG. 1 is a perspective view showing an exterior appearance of an image forming apparatus to which the present embodiment is applied;

FIG. 2 is a sectional view showing an internal structure of a color laser printer of the image processing apparatus;

FIG. 3 is block diagram showing the structure of a control system of the image processing apparatus;

FIG. 4 is a flowchart describing a print process performed by a control unit of the color laser printer;

FIG. 5A is a flowchart describing a transparent process included in the print process;

FIG. 5B is an explanatory view showing a composition of data registered in an interim data storage area;

FIG. 6 is a flowchart describing one part of the transparent process in detail;

FIGS. 7A-7J are explanatory views illustrating changes in a transparent process buffer and an image position control buffer caused by the transparent process;

FIGS. 8A-8D are explanatory views illustrating the changes in the transparent process buffer shown in FIGS. 7C, 7E, 7G, and 7I;

FIG. 9 is a flowchart describing a transparent process performed when the above-described transparent process is performed in a personal computer of the image processing apparatus;

FIGS. 10A-10C are explanatory views illustrating changes in a bitmap area caused by the transparent process in the personal computer;

FIGS. 11A and 11B are explanatory views illustrating an example of a simple transparent process;

FIGS. 12A, 12B are explanatory views wherein FIG. 12A illustrating an example of a group of object images, and wherein FIG. 12B illustrating an example of another object image over which the group of object images are written;

FIG. 13 is an explanatory view showing a positional relation in the group of object images;

FIG. 14 is an explanatory view illustrating an example wherein the group of object images is written over another object image by the transparent process;

FIG. 15 is an explanatory view illustrating a problem caused in a conventional art; and

FIG. 16 is an explanatory view illustrating an example of an attempt so as to solve the problem by using tags.

### DETAILED DESCRIPTION OF THE PREFERRED EMBODIMENT

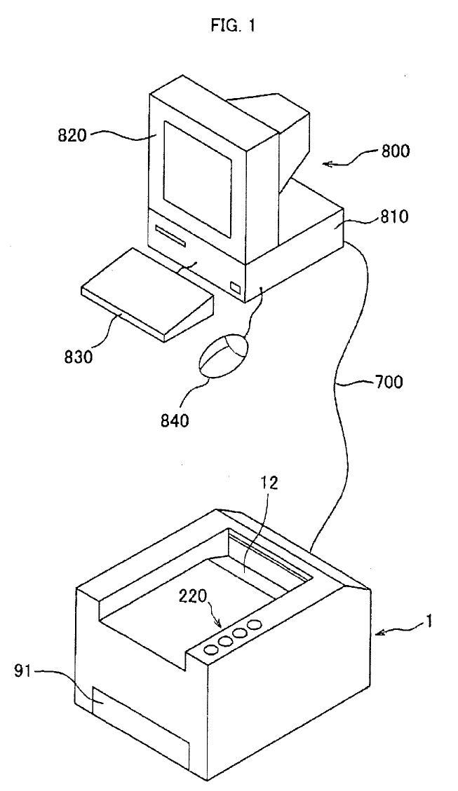

As shown in FIG. 1, an image processing apparatus according to the present embodiment includes a color laser printer (to be simply referred to as a printer) 1, and a personal computer (to be simply referred to a PC) 800 connected to the printer 1 via a cable 700. The printer 1 and the PC 800 may alternatively connected via a network, such as a LAN, an infrared communication, and the like.

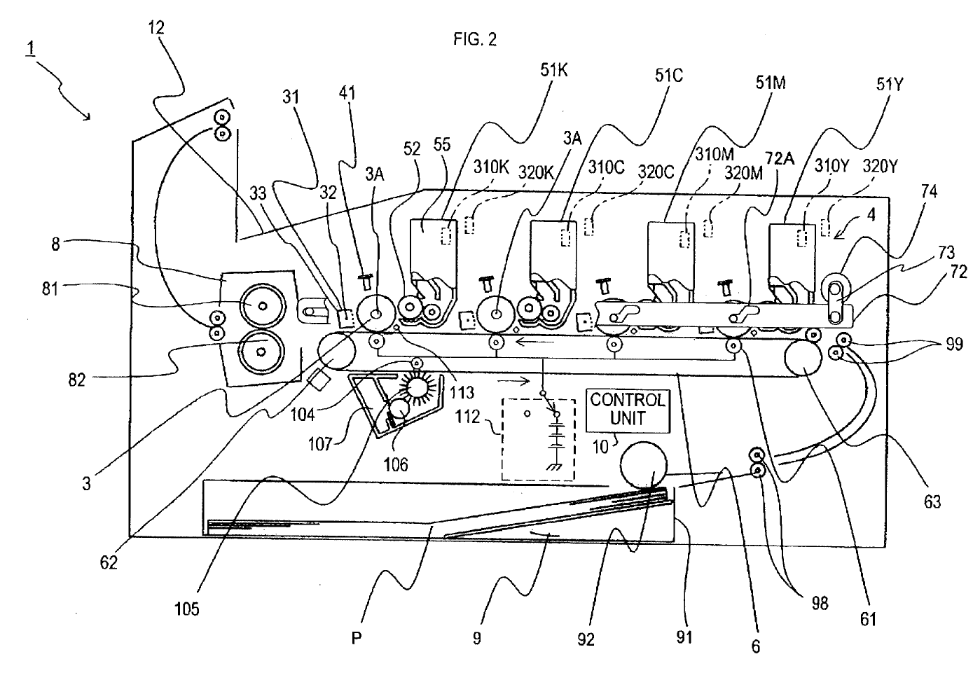

The printer 1, shown in FIG. 2, includes a toner image forming unit 4, a paper conveyance belt 6, fixation unit 8, a paper feed unit 9, a stacker 12, and a control unit 10. The printer 1 forms an image on a paper P in four colors corresponding to image data externally inputted.

The toner image forming unit 4 includes four development units 51Y, 51M, 51C, and 51K; photoreceptor drums 3, chargers 31, and scanner units 41. The development units 51Y, 51M, 51C, 51K respectively contain yellow, magenta, cyan, and black toners. The chargers 31 uniformly charge the photoreceptor drums 3 in process of toner image formation performed with the four colors of toners. The scanner units 41 respectively form latent images, which correspond to image data, by exposing the surfacer of the charged photoreceptor drums 3 with laser beams. It is to be noted that the major portions of the scanner units 41 are omitted in the drawing, and only the portions, from which laser beams are eventually emitted, are shown.

The following describes the construction of the respective constituents in detail. In the following description, when the constituents, provided for respective colors, need to be specifically distinguished by colors, the referential numerals indicating the constituents are followed by capital letters Y (for yellow), M (magenta), C (cyan), and K (black). However, when distinguish is not necessary, the constituents are generalized and indicated only by the referential numerals without any capital letters following thereafter.

The photoreceptor drums 3 of the toner image formation unit 4 are made of members approximately in cylindrical shapes, and disposed in a horizontal direction so as to interpose approximately equivalent intervals therebetween. The cylindrically-shaped members of the photoreceptor drums 3 are made by, for example, an aluminum base material and a positively charged photoreceptive layer formed thereon. The base material made of aluminum is connected to a ground line of the printer 1.

The chargers 31 are so-called scorotron type chargers. The chargers 31 respectively include charging wires 32 and shield cases 33. The charging wires 32 face the photoreceptor drums 3 and extend in the rotation-axis direction of the photoreceptor drums 3. The shield cases 33 have the charging wires 32 therein and configured to be open toward the photoreceptor drums 3. By applying a positive high voltage to the charging wires 32, the surfaces of the photoreceptor drums 3 are positively charged (for example, +700V). The open portions of the shield cases 33 toward the photoreceptor drums 3 are provided with grids. By applying a predetermined voltage to the grids, the surfaces of the photoreceptor drums 3 are charged at approximately equivalent voltage to the voltage applied to the grids.

The scanner units 41 are respectively disposed in a downstream side of the chargers 31 in the rotational direction of the photoreceptor drums 3. The scanner units 41 respectively emit laser beams from light sources corresponding to externally-inputted image data of respective colors. The laser beams are scanned by the surfaces of polygon mirrors (not shown) rotated by polygon motors (not shown), and emitted to the surfaces of the photoreceptor drums 3.

When laser beams, corresponding to image data, are emitted by the scanner units 41 onto the surfaces the photoreceptor drums 3, the electric potential decreases (to +150V to +200V) in the portion of the surfaces of the photoreceptor drums 3 exposed to the laser beams. As a result, latent images are formed on the surfaces of the photoreceptor drums 3.

The development units 51Y, 51M, 51C, and 51K respectively include development unit cases 55, containing respective colors of toners, and development rollers 52 disposed in the development unit cases 55. The development rollers 52 respectively contact with the photoreceptor drums 3 in a downstream side of the scanner units 41 with respect to the rotational direction of the photoreceptor drums 3. The respective development units 51 positively charge toners, and supply the toners to the photoreceptor drums 3 in a thin-layered manner. In the contact portions of the development rollers 52 and the photoreceptor drums 3, the above-described latent images are developed by applying the positively charged toners to the positively latent images formed on the surfaces of the photoreceptor drums 3 by a reversal development method.

The development rollers 52 are formed in a cylindrical shape, and made of a base material, for example conductive silicone rubber, and a coating layer made of resin including fluorine, or a rubber material. Yellow, magenta, cyan, and black toners are positively charged non-magnetic monocomponent toners, and contained in the respective unit cases 55 stored in the development units 51Y, 51M, 51C, and 51K.

The paper feed unit 9 is disposed in the bottom portion of the printer 1. The paper feed unit 9 includes a storage tray 91 and a pickup roller 92. The storage tray 91 stores paper P. The pickup roller 92 feeds paper P. Sheets of paper P stored in the storage tray 91 is picked up by the pickup roller 92 in a sheet-by-sheet manner from the paper feed unit 9, and fed to a paper conveyance belt 6 by conveyance rollers 98 and registration rollers 99.

The paper conveyance belt 6 is an endless belt having a width smaller than the width of the photoreceptor drum 3, and extending around a driving roller 62 and a driven roller 63. While the paper conveyance belt 6 holds a sheet of paper P on the top surface thereof, the paper conveyance belt 6 is driven together with the sheet of paper P. Across the paper conveyance belt 6, transfer rollers 61 are disposed so as to respectively face the photoreceptor drums 3. By the rotation of the driving roller 62, the paper conveyance belt 6 is driven in the counter clockwise direction in FIG. 2 as shown by arrows in the drawing. The paper conveyance belt 6 conveys a sheet of paper P, fed from the registration rollers 99, under the respective photoreceptor drums 3 and to the fixation unit 8. Below the surface of the paper conveyance belt 6 turned by the driving roller 62, a cleaning brush 105 is disposed.

Between the respective transfer rollers 61 and the respective photoreceptor drums 3, transfer bias (for example, 10-15 μA), having a polarity opposite to the polarity of the toners, is applied by a current source 112. Due to the transfer bias, the transfer rollers 61 transfer the toner images, formed on the photoreceptor drums 3, to a sheet of paper P conveyed by the paper conveyance belt 6. In FIG. 2, the current source 112 is illustrated such that the current source 112 can be switched so as to apply two levels (0V and a predetermined voltage) of transfer biases, because the illustration is simplified. The current source 112 is actually constructed so as to be able to provide different levels of voltage. Between the respective development rollers 52 and the respective transfer rollers 61, toner amount detection sensors 113 are disposed so as to detect the amount of toners maintained on the surfaces of the respective photoreceptor drums 3.

The cleaning brush 105 is constituted with a brush disposed around a cylindrical member extending in the width direction of the paper conveyance belt 6. A predetermined voltage is applied between the cleaning brush 105 and an electrode roller 104 facing the cleaning brush 105 via the paper conveyance belt 6 therebetween. The cleaning brush 105 contacts with the paper conveyance belt 6, and is rotated for cleaning. In vicinity of the cleaning brush 105, a waste toner remover 106 and a reservoir box 107 are disposed. The waste toner remover 106 removes toner adhered to the cleaning brush 106. The reservoir box 107 reserves toner removed from the cleaning brush 105.

The fixation unit 8 includes a heat roller 81 and a pressure roller 82. Toner images, transferred on a sheet of paper P, are fixed by applying heat and pressure while the heat roller 81 and the pressure roller 82 sandwich and convey the sheet of paper P.

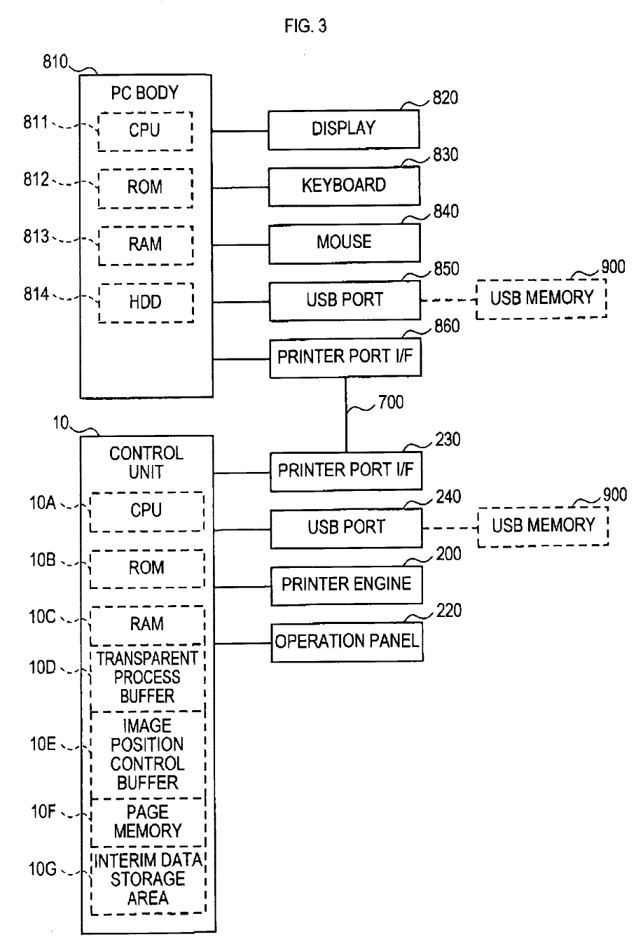

On the top surface of the printer 1, the stacker 12 is provided. The stacker 12 is disposed in the downstream side of the fixation unit 8 in the paper discharge direction, and receives paper P discharged from the fixation unit 8. The control unit 10, to be described more in detail later, includes a microcomputer having a CPU 10A (see FIG. 3), and controls the entire operation of the printer 1.

Four of the respective photoreceptor drums 3 are disposed such that the photoreceptor drums 3 can be moved in an upward direction so as to be away from the paper conveyance belt 6. The photoreceptor drums 3 are positioned by a movement member 72 disposed so as to extend between the four photoreceptor drums 3. The movement member 72 is made by plate-shaped members having lengths that are long enough for extending between the four of the photoreceptor drums 3. The movement member 72 is disposed so as to be movable in the left-to-right direction in FIG. 2. The movement member 72 is provided with four guide holes 72A formed approximately in crank-like shapes extending in the left-to-right direction. Longitudinal shafts 3A of the respective photoreceptor drums 3 are engaged with the respective guide holes 72A.

The movement member 72 is provided with a motor 74 connected via a link 73 which converts rotational force into force in the left-to-right direction. Corresponding to-a command signal from the control unit 10, the motor 74 is rotated, and the movement member 72 is moved in the right or the left direction. When the movement member 72 is moved in the left direction, the guide holes 72A are moved in the left direction, and the longitudinal shafts 3A of the respective photoreceptor drums 3 are moved upward along the crank-like shape of the guide holes 72A. Consequently, the photoreceptor drums 3 are moved away from the paper conveyance belt 6. On the other hand, when the movement member 7 is moved in the right direction, the longitudinal shafts 3A are moved downward along the guide holes 72, and the photoreceptor drums 3 contact with the paper conveyance belt 6. Image formation is usually performed while the photoreceptor drums 3 contact with the paper conveyance belt 6.

In the printer 1 according to the present embodiment configured as above, an image is formed on paper P as follows Firstly, a sheet of paper P is fed by the pickup roller 92 from the paper feed unit 9, and fed toward the paper conveyance belt 6 by the conveyance rollers 98 and the registration rollers 99, Subsequently, the surface of the photoreceptor drum 3Y, disposed in the extreme right hand side in FIG. 2, is uniformly charged by the charger 31, and exposed to a laser beam by the scanner unit 41 corresponding to externally inputted image data for yellow color. A latent image is formed on the surface of the photoreceptor drum 3Y as described above. Then, on the surface of the photoreceptor drum 3Y, yellow toner, positively charged in the development unit 51Y, is supplied, and development is performed. The toner image formed as above is transferred by the transfer roller 61, to which transfer bias is applied, onto the surface of the sheet of paper P conveyed by the paper conveyance belt 6.

The sheet of paper P is subsequently conveyed to positions so as to sequentially face the photoreceptor drums 3M, 3C, and 3K. Toner images in respective colors are formed on the surfaces of the photoreceptor drums 3M, 3C, 3K in the same manner as in when the yellow toner image is formed. The respective toner images are transferred by the transfer roller 61 so as to be overlapped on the sheet of paper P. Finally, the toner images in four colors, formed on the sheet of paper P, are fixed on the sheet of paper P in the fixation unit 8. Then, the sheet of paper P is discharged onto the stacker 12.

As shown by the phantom lines in FIG. 2, IC tags 310Y-310K are attached to the development unit cases 55Y-55K attachable/detachable to/from the printer 1. The IC tags 310Y-310K indicate information of the development units 51Y-51K, such as serial numbers thereof. To the body of the printer 1, IC tag readers 320Y-320K are provided so as to read the information from the IC tags 310Y-310K.

As shown in FIG. 3, the body 810 of the PC 800 includes a CPU 811, a ROM 812, a RAM 813, and a hard disc device (HDD) 814. To the PC body 810, a display (such as a CRT) 820, a keyboard 830, a mouse 840 are connected (see FIG. 1). Moreover, a USB port 860 and a printer port interface (to be referred to as printer port I/F) 860 are connected to the PC body 810. To the USB port 850, a USB memory 900 can be attached. The printer port I/F 860 is used so as to be connected to the printer 1.

The control unit 10 of the printer 1 is constructed as a microcomputer including a CPU 10A, a ROM 10B, and a RAM 10C. The RAM 10C includes a transparent process buffer 10D, a image position control buffer 10E, a page memory 10F, and an interim data storage area 10G for various settings.

The transparent process buffer 10D is an image buffer capable of storing color images, and constituted with four memory planes having a capacity of 8 bit/pixel so that images can be stored in 256 shade of yellow, magenta, cyan, and black in the respective planes. The image position control buffer 10E can store binary data which indicates whether or not a color image is stored. The image position control buffer 10E is constituted with one memory plane having a capacity of 1 bit/pixel, which is mutually used for all of the four colors. The page memory 10F is constituted with four memory planes having a capacity of 8 bit/pixel which are respectively used for the four colors. The interim data storage area 10G stores interim data (so called vector data), which is in a form of data prior to visualization, such as a type or angles of a graphical form, coordinate data, a filling color (265 shades), and so on.

To the control unit 10, various actuators (to be referred to as printer engine 200), an operation panel 220, a printer port interface (to be referred to as printer port I/F) 230, and a USB port 240 are connected. The printer engine 200 is mechanical constituents used for image forming operation from the paper feed unit 9 to the fixation unit 8. The operation panel 220 is disposed on the surface of the printer 1 (see FIG. 1). The printer port I/F 230 is used so as to be connected to the PC 800. To the USB port 240, a USB memory 900 can be attached.

The following describes the control process performed by the control system described above. When a user draws a graphical form by using the PC 800 based on a drawing application stored in the HDD 814, and instructs printing of the graphical form, the PC 800 sends data of object images forming the graphical form to the printer 1 as a series of PDL commands. The series of PDL commands are sequentially sent from a PDL command, corresponding to an underlying image object, to a PDL command corresponding to an overlying image object. When PDL commands for all of the object images in one page are sent, a print command is sent.

When the series of PDL commands for printing is inputted into the printer port I/F 230, the control unit 10 of the printer 1 executes the following process.

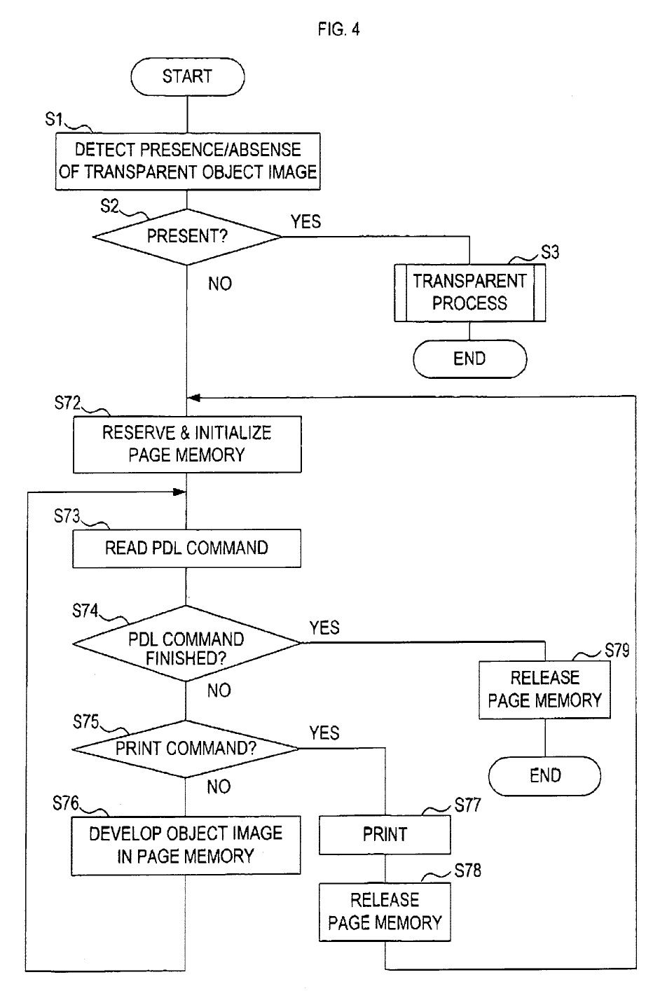

As shown in FIG. 4, when the process is initiated, in S1, it is detected whether or not the series of PDL commands include a command for a transparent object image whose degree of opacity is smaller than 1. In S2, it is determined whether or not the detection result in S1 is affirmative. If the detection result is affirmative (S2:Y), a transparent process is performed in S3.

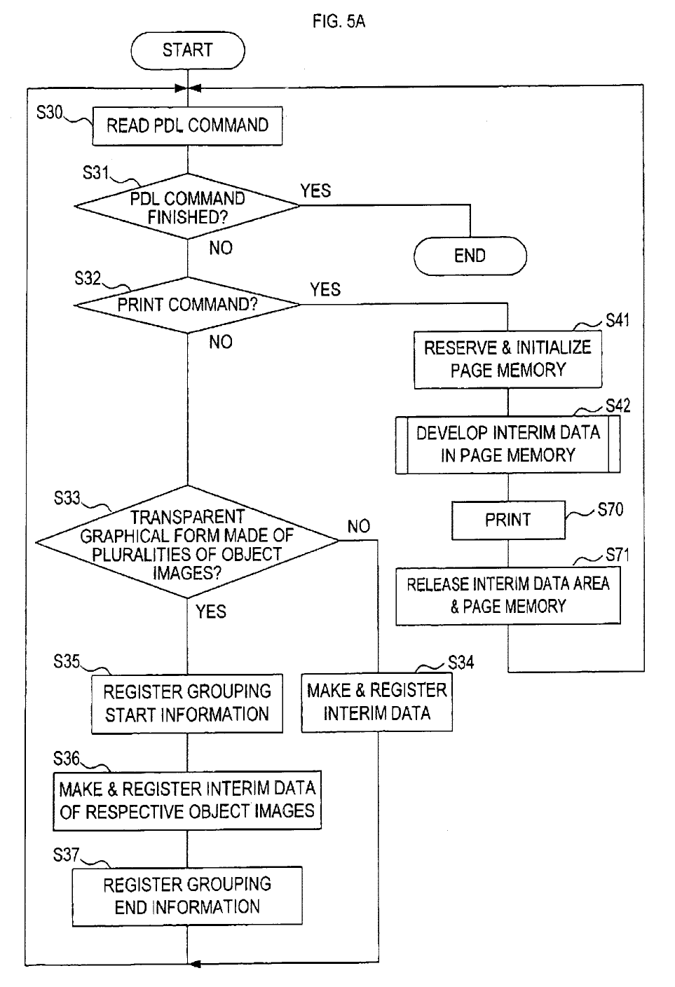

In the transparent process shown in FIG. 5A, the series of PDL commands, received as above, are sequentially read from the head of the series. Reading of PDL commands is performed with respect to one PDL command in S30, and repeatedly performed until it is determined, in S31, that reading of the PDL commands has been finished. In S30, if a graphical form, constituted with a group of graphical forms, is represented in a plurality of PDL commands, the plurality of PDL commands is read as a group of commands. In S31, it is determined, whether or not reading of the PDL commands has been finished. If reading has not yet been finished (S31:N), in S32 it is determined whether or not the PDL command read in S30 is a print command.

If the PDL command read in S30 is not a print command (S32:N), the PDL command is a command corresponding to a graphical form constituted with a group of graphical forms. In this case, the process proceeds to S33 wherein it is determined whether or not the graphical form is a transparent graphical form constituted with a plurality of object images. If it is determined that the graphical form is not a transparent graphical form constituted with a plurality of object images (S33:N), in S34 interim data corresponding to the graphical form (that is, non-transparent object images, or a single transparent object image that does not form a group) is made, and registered in the interim data storage area 10G. Then, the process goes back to S30, and the process is executed with respect to a subsequent PDL command.

On the other hand, if the PDL command read in S30 corresponds to a transparent graphical form constituted with a plurality of object images (S33:Y), in S35 grouping start information is registered in the interim data storage area 10G. In S36, interim data with respect to the plurality of object images is sequentially made from the object image underlying the lowermost (that is, the object image whose PDL command is positioned in the head of the series of PDL commands). The interim data is registered into the interim data storage area 10G. In S37, grouping end information is registered in the interim data storage area 10G, and the process goes back to the above-described S30 so as to perform the process with respect to a subsequent PDL command.

The composition of the data registered in the interim data storage 10G in S35, S36, and S37 is shown in FIG. 5B. In the following, the data stored in the interim data storage area is referred to as object data.

On the other hand, if the PDL command read in S30 is a print command (S32:Y), the process proceeds to S41 wherein a memory area is reserved in the page memory 10F so as to save data in one page, and the reserved memory area is initialized. In S42, interim data which has been registered in the interim data storage area 10G is developed in the page memory 10F as follows.

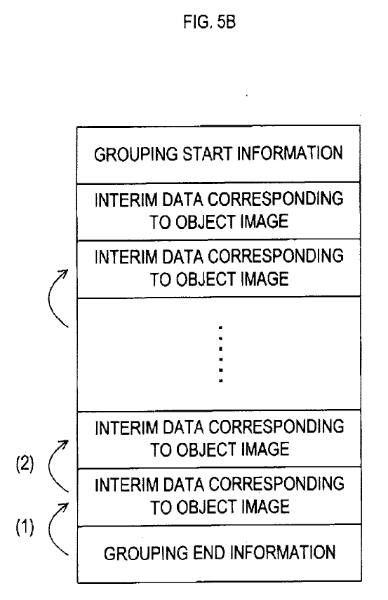

As shown in FIG. 6, in S51, a memory area in the transparent process buffer 10D is reserved as much as necessary to develop the interim data in one page into color images in which colors respectively have 256 shades. Then, the reserved memory area is initialized. In S52, a memory area in the image position control buffer 10E is reserved as much as necessary to store binary image data in one page into monochrome (filled in black).

In S53, object data is selected. As described above, interim data of object images or/and grouping start information and grouping end information are registered in the interim data storage area 10G by the process of S34, or the processes of S35, S36, and S37. In S53, the object data is read in the order in which the object data is registered.

Data processing is performed from object data disposed the lowermost in the present embodiment. In order to find the object data disposed lowermost, the following process, briefly described in blow, is performed. Firstly, it is determined whether or not the selected object data is grouping start information (S54). If the selected object data is grouping start information, the object data, shown in FIG. 5B, is checked from the top to the bottom so as to search grouping end information (S59). If grouping end information is found interim data corresponding to an object image, which is disposed immediately before the grouping end information, is selected (S60).

More specifically, the following process is performed. In S54, it is determined whether or not the object data selected in S53 is grouping start information. Since grouping end information is not supposed to be registered prior to grouping start information, if it is determined that the selected object data is not grouping start information (S54:N), the selected object data is interim data corresponding to an object image which does not require the transparent process, or a single object image that requires the transparent process. In this case, the process proceeds to S55 wherein the selected interim data is developed in the transparent process buffer 10D as a color image in which colors respectively have 256 shades. If the object data selected in S53 is interim data corresponding to a single object image which requires the transparent process, the color of the overlapping portion of the single object image overlapping with another object image, or a colored background, becomes a blended color obtained by calculating the following formula,

BL=(1−α)*CUO+α*COO (1)
BL: blended color
CUO: color of underlying object image
COO: color of overlying object image

In the above formula, a represents a degree of opacity having a value between 0.0 and 1.0. Colors are assigned with numeric color values which specify the colors among, for example, 256 shades.

Subsequently, in S56, it is determined whether or not all of the data stored in the interim data storage area 10G have been processed, and all of the object images have been developed. If it is determined that not all of the object images have been developed (S56:N), the process goes back the above-described S53, and a subsequent object data is selected.

On the other hand, if the object data selected in S53 is grouping start information (S54:Y), the process proceeds to S58 wherein the memory area in the image position control buffer 10E reserved in S52 is initialized. In S69, the group end information registered in the above-described S37 is searched and selected as object data. In S60, the object data disposed immediately before the object data selected in S53 is selected. In S61, it is determined whether or not object data selected in S60 is grouping start information. The selection order of object data is shown in FIG. 5B with arrows and numbers.

If it is determined that the object data selected in S60 is not grouping start information (S60:N), the selected object data is interim data corresponding to a transparent object image, constituted with a plurality of object images (see S35-S37). In this case, the process proceeds to S62 wherein the selected interim data is developed in the transparent process buffer 10D with reference to the data stored in the image position control buffer 10E. That is, the object image corresponding to the selected interim data is written as an image, by using the above-described formula (1), in an area of the transparent process buffer 10D such that the silhouette of the image does not overlap with other silhouettes to be written in the image position control buffer 10 in a manner to be described later. In S63, a portion of the image position control buffer 10E corresponding to the image position of the object image written in S62 is turned on. Then, the process goes back to the above-described S60.

As described above, a transparent object image, constituted with a plurality of object images is developed in the transparent process buffer 10D in a bottom-to-top order as shown in FIG. 513. When grouping start information is finally selected (S61:Y), the process proceeds to S64.

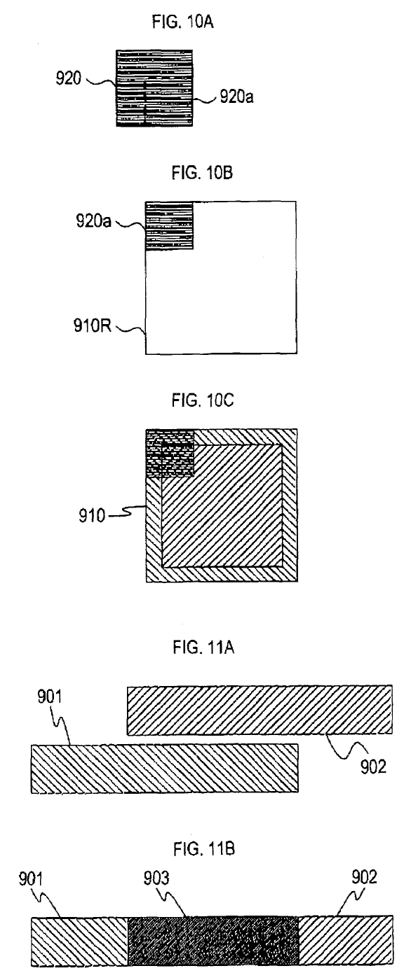

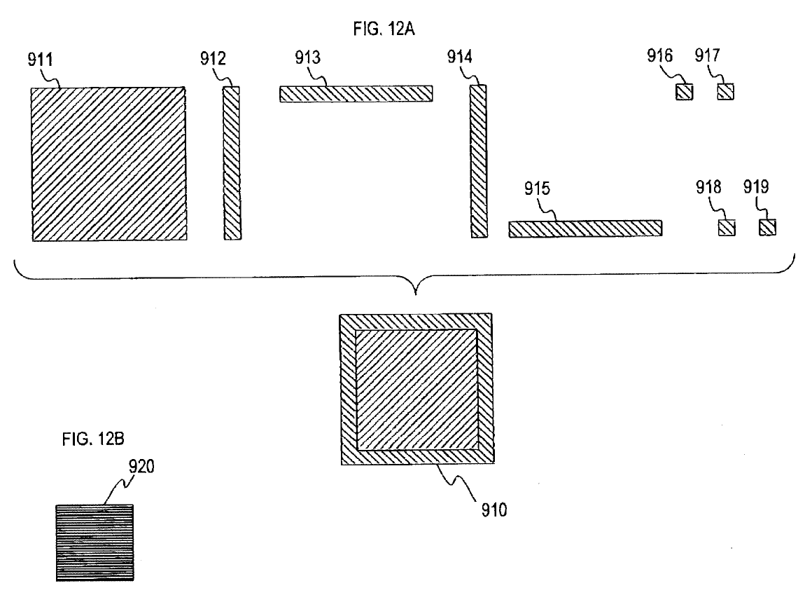

A loop process of S60-S63 is specifically explained below with the foregoing example. In the above-described example, a case is described wherein the object image 910, constituted with the object images 911-919 (see FIG. 12A) sequentially written over one another, is overlapped on another object image 920 by the transparent process. For convenience sake, the following merely describes overwriting of the object images 911, 912, 913, and 916 overlapping with the object image 920.

In this case, the PDL commands corresponding to the object images 911, 912, 913, and 916 are sequentially received in this order. Interim data thereof are registered in the same order (see S36). However, in the processes of S59 and S60, the interim data are selected in a reversed order.

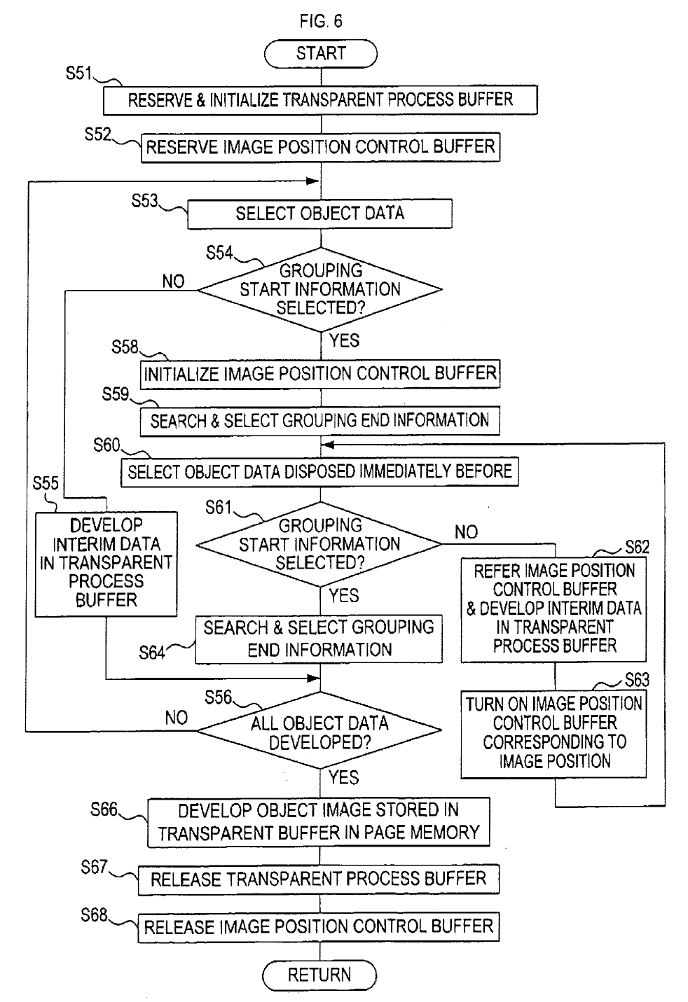

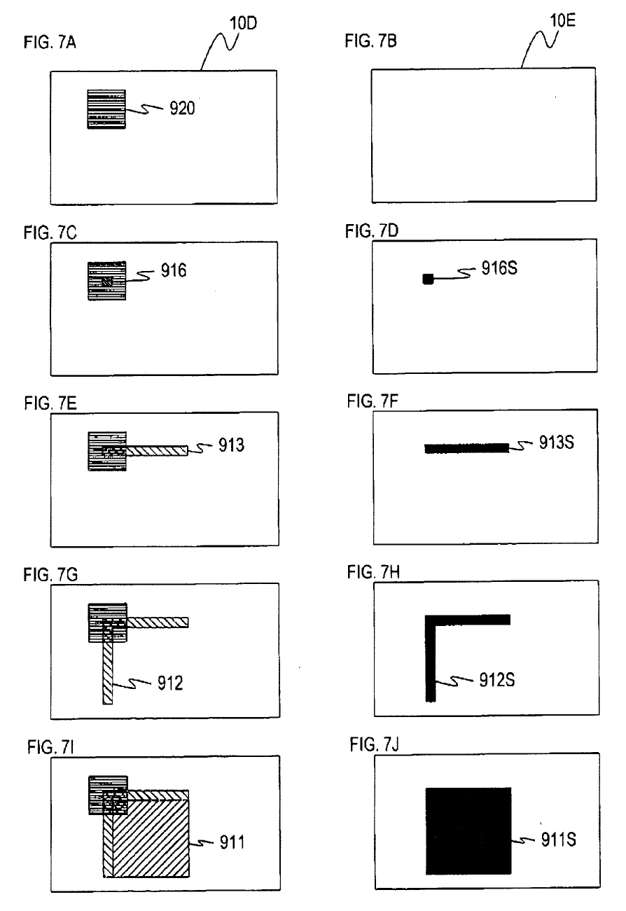

When the process proceeds to S62 for the first time, as shown in FIG. 7A, the object image 920 underlying the object image 910 is written in the transparent process buffer 10D (see S55). As shown in FIG. 7B, the image position control buffer 10E remains in the initialized state (see S58). By the process of S62, as shown in FIG. 7C, the transparent process by the above-described formula (1) is performed with respect to the object image 916 lying uppermost among the object images 911, 912, 913, and 916. Then, the object image 916 is written in the transparent process buffer 10D. For better understanding, this state is shown in FIG. 8A without the object 920.

In S63, a portion of the image position control buffer 10E corresponding to the image position of the object image 916 is turned on, and a silhouette 916S of the object image 916 is written in the image position control buffer 10E.

When the process goes back to S62, as shown in FIG. 7E, the transparent process is performed with respect to the object image 913. The object image 913 is written in the transparent process buffer 10D such that a silhouette 913S of the object image 913 will be written in the image position control buffer 10E without overlapping with the silhouette 916S. For better understanding, this state is shown in FIG. 8B without the object 920. Subsequently, in S63, as shown in FIG. 7F, the silhouette 913S of the object image 913 is written in the image position control buffer 10E.

In the same manner as described above, the transparent process is performed with respect to the object image 912 as shown in FIG. 7G. The object image 912 is written in the transparent process buffer 10D such that a silhouette 912S of the object image 912 will be written in the image position control buffer 10E without overlapping with the silhouettes 916S and 913S (S62). For better understanding, this state is shown in FIG. 8C without the object image 920. Then, as shown in FIG. 7H, the silhouette 912S of the object image 912 is written in the image position control buffer 10E (563).

Furthermore, as shown in FIG. 7I, the transparent process is performed with respect to the object image 911. The object image 911 is written in the transparent process buffer 10D such that a silhouette 911S of the object image 911 will be written in the image position control buffer 10E without overlapping with the silhouettes 916S, 913S, 912S (S62). For better understanding, this state is shown in FIG. 8D without the object image 920. Subsequently, as shown in FIG. 7J, the silhouette 911S of the object image 911 is written in the image position control buffer 10E (S63).

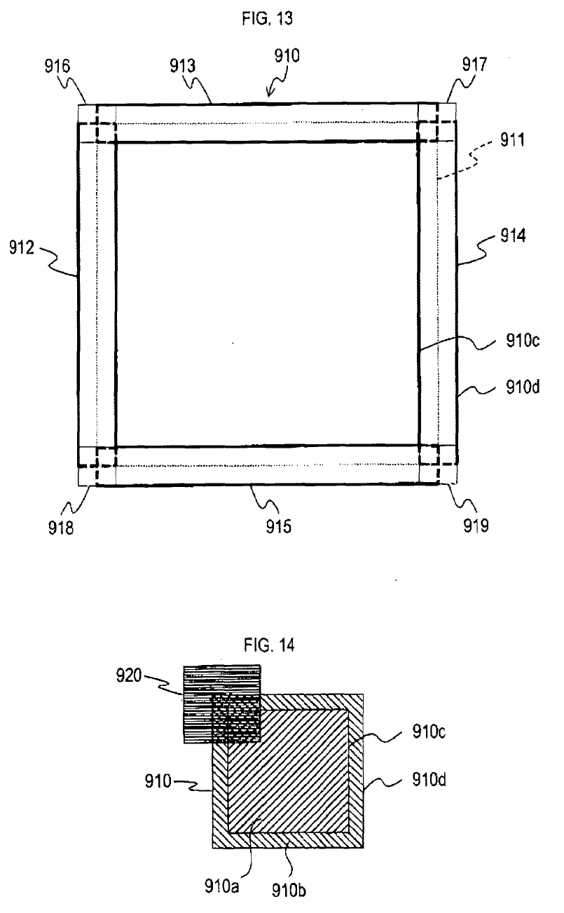

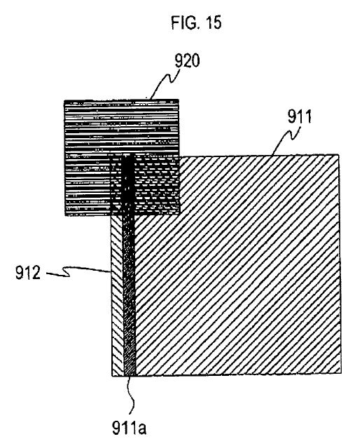

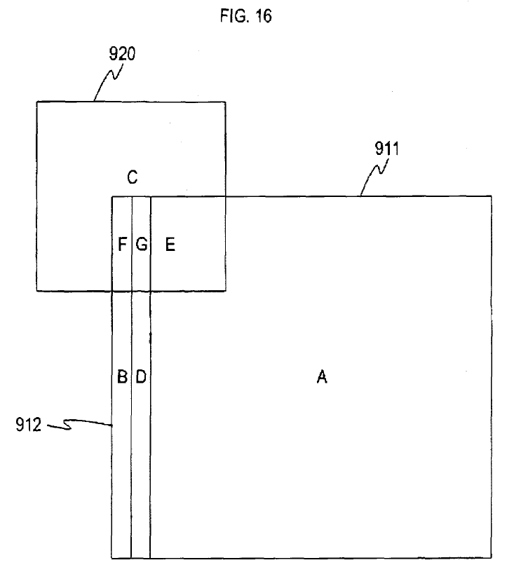

When such procedure is performed with respect to the object images 911-919, as shown in FIG. 14, the object image 910 constituted by the object images 911-919 written over one another (see FIG. 12A) can be overlapped on another object image 920 by the transparent process.

Referring again to FIG. 6, when a transparent graphical form composed of a plurality of object images is written in the transparent process buffer 10D as described above, grouping start information is selected in S60. In S61, an affirmative determination is made, and then the process proceeds to S64. In S64, grouping end information is searched and selected. Then, the process proceeds to above-described S66. When the process goes back again to S53, subsequent object data registered after the object data in regard to the above-described transparent graphical form (that is, the grouping start information, interim data of the plurality object images, and the grouping end information sequentially registered in this order) is selected. Then, the above-described processes are repeated.

When development of all of the object images are finished (S56:Y), the process proceeds to S66 wherein the object images developed in the transparent process buffer 10D are developed in the page memory 10F. That is, 8 bit/pixel data developed in the transparent process buffer 10D is converted into 1 bit/pixel data for driving the printer engine 200, and developed into the page memory 10f.

Subsequently in S67, the transparent process buffer 10D is released. In S68, the image position control buffer 10E is released. Then, the process proceeds to S70 in FIG. 5. In S70, printing is performed by driving the printer engine 200 with the data developed in the page memory 10F. In S71, the interim data storage area 10G and the page memory 10F are released. Then, the process goes back to S30. When processing of all of the PDL commands inputted into the printer port I/F 230 is finished (S31:Y) by rep-eating the above described processes, the process executed by the control unit 10 is temporarily finished.

Referring again to FIG. 4, if it is determined that the PDL command, inputted into the printer port I/F 230, is not a command corresponding to a transparent object (S2:N), the process proceeds to S72 wherein reserving and initializing in the page memory 10F is performed. In S73-S75, processes are performed in the same manner as in S30-S32: one of the series of PDL commands is read (S73); it is determined whether or not reading of the PDL commands has been finished (S74); and it is determined whether or not the PDL command is a print command (S 75).

If the PDL command is not a print command (S75:N), the PDL command corresponds with a non-transparent object image. In this case, in S76 the opaque object image is directly developed into the page memory 10F. Subsequently, the process goes back to S73 so as to read a subsequent PDL command. As described above, the objects images are sequentially developed and overwritten in the page memory 10F (S76). When a print command is read (S75:Y), printing is performed in S77 in the same manner as in S70. Subsequently in S78, the page memory 10F is released. The process goes back to the above-described S72. When all of the PDL commands, inputted into the printer port I/F 230, are processed (S74:Y) by repeating the above-described processes, in S7 the page memory 10F is released, and then, the process executed by the control unit 10 is temporarily finished. If there is no transparent object image (S2:N), neither of the transparent process buffer 10D nor the image position control buffer 10E is used, and no interim data is made. Therefore, the processing can be performed faster.

As described above, in the present embodiment, an object image (for example, the object image 910), constituted with a plurality of object images by sequentially writing an overlying object image over an underlying object image, can be overlapped onto another object image by the simple transparent process. In the transparent process, object images composing the group are sequentially overwritten such that a silhouette of an object image does not overlap with a silhouette of an object image that has been already written in the image position control buffer 10E. Moreover, the image position control buffer 10E, required specially for such process, needs to have a capacity only enough to store binary data in one page. Therefore, in the present embodiment, the transparent process described as above can be performed fast with a small memory capacity.

If data of an object image, constituted with a plurality of object images, are aligned in the same manner as the above-described PDL commands, that is in the order from data corresponding to an object image lying the lowermost, the data of the respective object images are read in a reverse order opposite to the alignment order. In this case, attaching an attribute so as to specify which data corresponds to data of an overlying object image is not necessary. Therefore, the processing can be simplified and requires an even smaller memory capacity;

It is to be noted that the present embodiment is not limited to the above-described embodiment. Variations and modifications are possible without departing from the scope of the present invention. For example, in the above-described embodiment, an example is described wherein the object image 910, constituted by sequentially writing the object images 911-919 over one another, is overlapped on another object image 920 by the transparent process. However, the present invention may be also applied to a case wherein an object image, constituted by sequentially writing a plurality of object images over one another, is overlapped on a background filled by a single color. Moreover, in the above-described embodiment, the presence/absence of a transparent object image is firstly detected. However, if the process capacity of the control unit 10 is sufficiently high, the transparent process in S3 may be immediately performed irrespective of the presence/absence of a transparent object image.

Furthermore, if the image position control buffer 10E is provided with a memory capacity enough to store binary data for a minimum rectangular area including an entire object image constituted with a plurality of object images, the transparent process may be performed with a smaller memory capacity. However, in this case, since the capacity used in the image position control buffer 10E changes depending on every object image, reserving an area in the image position control buffer 10E, originally performed in S52, is performed immediately before S58, and releasing the image position control buffer 10E, originally performed in S67, is performed immediately after S64.

Still furthermore, the processes in FIGS. 4, 5, and 6 may be also applied to so called direct printing. In this case, PDL commands made by the PC 800 are stored in the USB memory 900, and the USB memory 900 is inserted into the USB port 240 of the printer 1 so that the control unit 10 reads the commands therefrom.

Moreover, the aforementioned embodiment describes that PDL commands are aligned in the order from a PDL command corresponding to an underlying object image to a PDL command corresponding to an overlying object image. However, not only the alignment order of PDL commands, but also the order for analyzing PDL commands or processing PDL commands in accordance with the format of the PDL commands may be also in the same order as the alignment order.

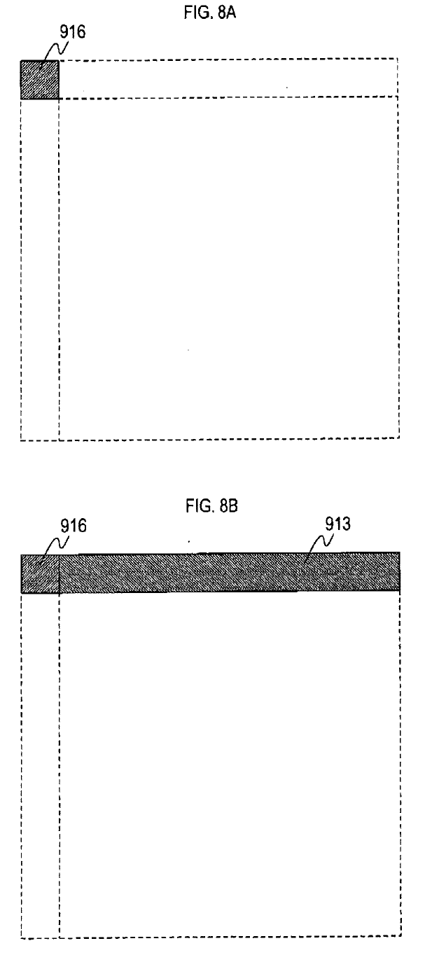

Furthermore, for some types of printers, in which the above-described transparent process cannot be internally performed, the transparent process may be performed as follows by using the PC 800. When a user draws graphical forms by PC 800 based on a drawing application or the like, and instructs printing, a process, shown in FIG. 9, is performed based on a program stored in the HDD 814.

As shown in FIG. 9, when the process is initiated, firstly in S81, one of the graphical forms is selected. In this process, graphical forms are sequentially selected from an underlying graphical form to an overlying graphical form. In S82, it is determined whether or not selected graphical form is a transparent graphical form. If the selected graphical form is not a transparent graphical form (S82:N), in S83 the graphical form is converted into PDL commands. The PDL commands are sent to the printer 1 by a routine process (not shown). In S84, it is determined whether or not all of the graphical forms have been converted into PDL commands. If not all of the graphical forms have been converted yet (S84:N), the process goes to the above-described S81 wherein a subsequent graphical form is selected.

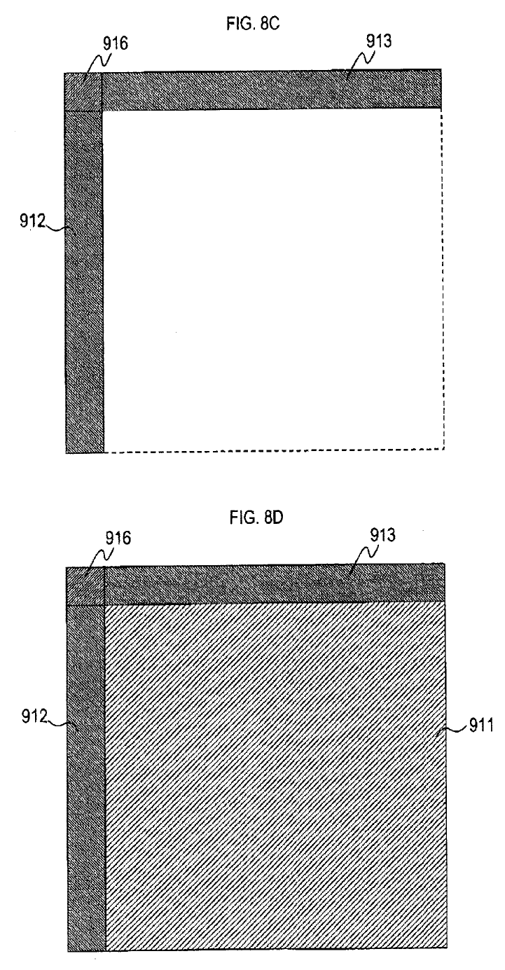

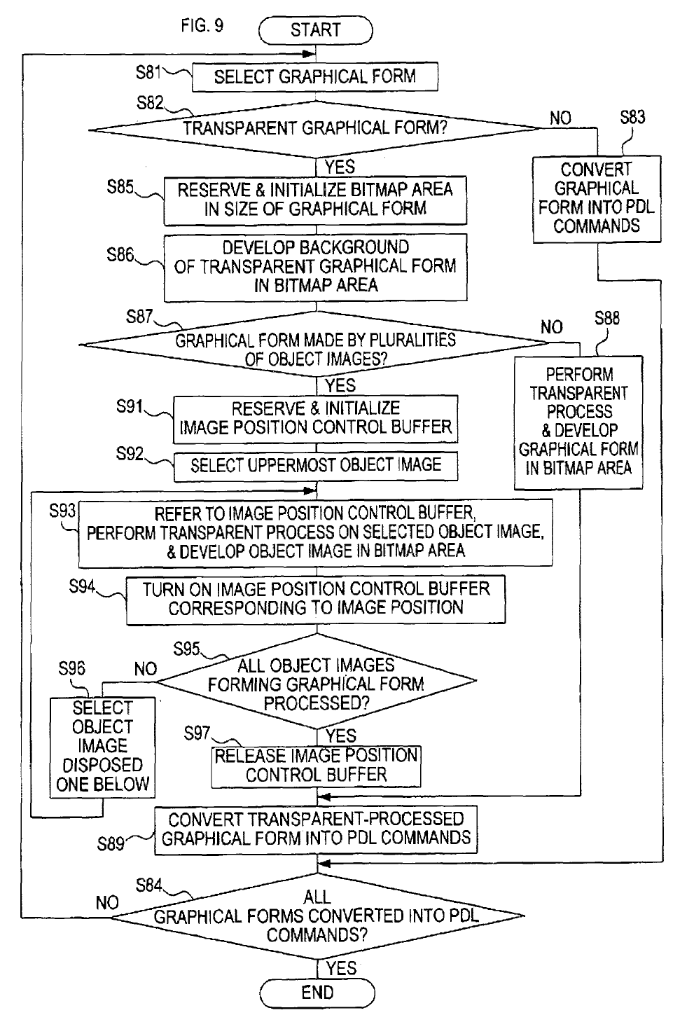

On the other hand, if the selected graphical form is a transparent graphical form (S82:Y), in S85 a bitmap area is reserved in the RAM 813 corresponding to the size of the transparent graphical form, and the reserved area is initialized. In S86, a background of the transparent graphical form is developed in the above-described bitmap area. For example, in a case wherein the above-described transparent object image 910 is overlapped on the object image 920, a bitmap area is reserved corresponding to the size of the object image 910, and initialized (S85). Subsequently, a portion 920a of the object image 920, shown in FIG. 10A, is cut along a portion of an outline 910R of the object image 910, and is developed in the bitmap area as shown in FIG. 10B (S86).

In S87, it is determined whether or not the currently selected transparent graphical form is a transparent graphical form constituted with a plurality of object images. If it is determined that the currently selected transparent graphical form is constituted with a single object image (S87:N), the process proceeds to S88. In S88, the transparent process is performed with respect to the selected transparent graphical form in accordance with the above-described formula (1), and the transparent graphical form is developed in the above-described bitmap area. In S89, the transparent graphical form, on which the transparent process has been performed, is converted into PDL commands. Then, the process proceeds to the above-described S84.

On the other hand, if it is determined that the currently selected transparent graphical form is constituted with a plurality of object images (SB7:Y), the process proceeds to 891. In S91, an image position control buffer having a size corresponding to the size of the above-described bitmap area is reserved in the RAM 813, and initialized. In S92, an object image positioned uppermost is selected. In S93, in the same manner as in S62, the transparent process is performed with respect to the selected object image. With reference to the data in the image position control buffer, the selected object image is developed in an area of the above-described bitmap area such that the silhouette of the selected object image will not overlap with silhouettes already written in the image position control buffer. In S94, in the same manner as in the above-described S63, a portion of the image position control buffer corresponding to the image position of the selected object image is turned on. Then, the silhouette of the selected object image is written.

In S95, it is determined whether or not processing has been completed with respect to all of the object images constituting the above-described transparent graphical form. If it is determined that the process has not yet been completed (S95:N), an object image underlying immediately below the previously selected object image is selected in S96. Then, the process goes back to S93. When processes of S93 and S94 have been completed with respect to all of the object images constituting the transparent graphical form (S95:Y), in S97 the image position control buffer is released. Then, the process goes to the above-described S89.

If the processes of S91-S96 are performed with respect to the bitmap area shown in FIG. 10B, a bitmap image shown in FIG. 10C is made. In S89, the bitmap image is converted into PDL commands. Such bitmap image is directly written over the object image 920. As a result, an image shown in FIG. 14 can be obtained. Therefore, in this case, the same effect can be achieved as in the above-described embodiment, even if the printer 1 is not adapted for the transparent process.

Moreover, the process of FIG. 9 can be also applied to so-called direct printing wherein image data made by the PC 800 is recorded into the USB memory 900, and the USB memory 900 is inserted into the USB port 240 so that the control unit 10 reads the image data. The data recorded in the USB memory 900 is unlike PDL command. In some cases, the data in the USB memory 900 are not arranged in an order from data corresponding to an object image lying lowermost. Even in this case, the same effect can be achieved as in the above-described embodiment by performing the process shown in FIG. 9 from an object image lying lowermost. However, in this case, the conversion processes (S83, S89) in FIG. 9, wherein conversion into PDL commands is performed, should be replaced by development processes, wherein development into the page memory 10F is performed. As for the recording medium which records image data, not only a USB memory, but also other semi-conductive recording media, such as a memory card, can be used.

Furthermore, the formula used in the transparent process is not limited to the above-described formula (1). Still further, a part of the process performed by software in the above-described embodiment and variations may be performed by hardware. For example, the processes of S55, S62, wherein interim data is developed in the transparent process buffer 10D, may be performed by hardware. In this case, the processes can be performed even faster.

Although specific embodiment and variations have been illustrated and described herein, it is to be understood that the above description is intended to be illustrative, and not restrictive. Combinations of the above embodiment and variations will be apparent to those of skill in the art upon reviewing the above other applications in which the above structures are used. Accordingly, the scope of the invention should only be determined with reference to the appended claims, along with the full scope of equivalents to which such claims are entitled.

What is claimed is:

1. An image processing apparatus comprising:
an overwriter that overwrites a plurality of images over another image by performing a transparent process in a writing order from one of the plurality of images disposed uppermost;
an area storage that stores areas in each of which each of the plurality of images is written by the overwriter; and
a controller that controls the overwriter so as to write the plurality of images such that, when each of the plurality of images is written in the writing order, the areas of the plurality of images do not overlap with the areas already stored by the area memory.

2. The image processing apparatus as set forth in claim 1 further comprising a first image data storage that stores data of the plurality of images in an alignment order from one of the plurality of images disposed lowermost,
wherein the overwriter reads and overwrites the data of the plurality of images in a reverse order of the alignment order.

3. The image processing apparatus as set forth in claim 2 further comprising a second image data storage that stores data of the another image,
wherein the overwriter performs the transparent process so as to combine each of the plurality of images with the another image, stored by the second image data memory, and overwrites each of the plurality of images, with respect of which the transparent process is performed, in the second image data memory.

4. The image processing apparatus as set forth in claim 1 further comprising a clipper that cuts out a portion of the another image overlapping with the plurality of images,
wherein the overwriter comprises a bitmap data creator that creates bitmap data with respect to the portion cut out by the clipper, when the overwriter performs the transparent process and writes each of the plurality of images over the another image.

5. An image processing apparatus that overlaps a plurality of object images, the apparatus comprising:
an overwriter that writes the plurality of object images, constituted by sequentially overwriting one of the object images overlying on top of one of the object images underlying, the overwriter writing the plurality of object images over one of another object image and a background by performing a transparent process in a writing order from one of the plurality of object images disposed uppermost; and
an area storage that stores areas in each of which each of the plurality of object images is written by the overwriter, the overwriter overwriting each of the plurality of object images such that the areas of the plurality of object images do not overlap with the areas already stored by the area memory.

6. The image processing apparatus as set forth in claim 5,
wherein data of the plurality of object images are aligned in an alignment order from one of the plurality of object images disposed lowermost, and
wherein the overwriter reads and overwrites the data of the plurality object images in a reverse order of the alignment order.

7. The image processing apparatus as set forth in claim 6 further comprising an image data storage that stores one of the another object image and a background,
wherein the overwriter performs the transparent process so as to combine each of the plurality of object images with one of the another object image and the background stored by the memory, and overwrites each of the plurality of object images with respect of which the transparent process is performed in the image data storage.

8. The image processing apparatus as set forth in claim 5 further comprising a clipper a clipper that cuts out a portion of one of the another image and the background overlapping with the plurality of images,
wherein the overwriter comprises a bitmap data creator that creates bitmap data with respect to the portion cut out by the clipper, when the overwriter performs the transparent process and writes each of the plurality of object images over one of the another image and the background.

9. An image processing method comprising steps of:
overwriting each of a plurality of images on another image by performing a transparent process in a writing order from one of the plurality of images disposed uppermost, the overwriting being performed when the plurality of images, constituted by sequentially overwriting one of the images overlying on top of one of the images underlying, is written over the another image by performing the transparent process; and
storing areas in each of which each of the plurality of images are written, the overwriting of the plurality of images being performed in the writing order such that the areas of the plurality of images do not overlap with the areas already stored by the area memory.

10. An image processing method so as to overlap a plurality of object images, the method comprising:
an overwriting process so as to overwrite each of a plurality of object images on one of another image and a background by performing a transparent process in a writing order from one of the plurality of object images disposed uppermost, the overwriting being performed when the plurality of object images, constituted by sequentially overwriting one of the object images overlying on top of one of the object images underlying, is written over one of the another image and the background by performing the transparent process; and
an area storing process so as to store areas in each of which each of the plurality of images are written by the overwriting process, the overwriting process and the area storing process being repeatedly performed, the overwriting process being performed with respect to the each of the plurality of object images in the writing order such that the areas of the plurality of object images do not overlap with the areas already stored by the area storing process.
